(19) United States
(12) Patent Application Publication
(10) Pub. No.: US 2005/0015782 A1
(43) Pub. Date: Jan. 20, 2005

(54) Optical disc apparatus for disc flutter improvement in disc drive

(75) Inventor: Kuo-Jen Wang, Taoyuan (TW)

Correspondence Address: Richard P. Berg. Esq.;c/o LADAS & PARRY, Suite 2100, 5670 Wilshire Boulevard, Los Angeles, CA, 90036-5679, US

(73) Assignee: BENQ CORPORATION

(21) Appl. No.: 10/892,942

(22) Filed: Jul. 16, 2004

(30) Foreign Application Priority Data
Jul. 18, 2003 (TW) 092119690

(51) Int. Cl. G11B 17/03

(52) U.S. Cl. 720/603

(57) ABSTRACT

The present invention provides a tray used in an optical disc apparatus for supporting a disc. The tray comprises an accommodation concave for placing the disc, a plurality of hooks around the accommodation concave, and at least one air-guiding opening disposed between the adjacent hooks in the front zone of the tray. The hooks prevent the disc from falling out of the accommodation concave. Such configuration improves the disc vibration when the disc is rotating.

### BACKGROUND OF THE INVENTION

1. Field of the Invention

The present invention relates to an optical disc apparatus for improving the disc flutter when the disc is rotating, especially to an optical disc apparatus comprising a tray with an air-guiding opening in the front zone.

2. Description of the Prior Art

In general, people use optical disc apparatus to read/write data on a disc. The optical disc apparatus comprises a tray, a housing, a chassis, and an OPU (optical pick-up unit). The tray accommodates a data-storing disc, such as CD (compact disc) or DVD (digital versatile disc), and the disc is rotated by a spindle motor for the OPU to process data. When the optical disc apparatus operates, disc spinning results in a fluctuating airflow and the structure of the tray aggravates it. This is one reason of disc vibration (disc flutter), and disc flutter is detrimental to data reading/writing on the disc.

FIG. 1 shows a conventional tray 10 of an optical disc apparatus. A disc 11 is placed in a accommodation concave of the tray 10, and hooks 12, 14, 16 and 18 are around the accommodation concave to prevent the disc 11 from falling out of the tray 10 especially when the optical disc apparatus is set vertically. Usually there is a disc clamper on the housing of the optical disc apparatus to hold the disc. The tongue-shaped opening 15 is for a spindle motor (not shown in figures) to rotate the disc 11 so that an OPU (not shown in figures) can process the data on the disc 11. When the disc 11 is rotating, the air around the disc 11 flows and forms the fluctuating airflow. Meanwhile, the hooks 12, 14, 16 and 18 block and make the fluctuating airflow worse, which causes disc flutter (disc vibration). Disc flutter is more severe when the disc is rotated at a speed over 9600 rpm.

As shown in FIG. 1, the fluctuating airflow is much worse in the front zone of the tray 10 since there is no appropriate opening between hooks 12 and 16 to release the fluctuating airflow. The fluctuating airflow further decreases the stability of the rotating disc 11, which is bad for data reading/writing.

FIG. 2A shows a list of total flutter values measured from a disc under different rotational frequencies in a conventional optical disc apparatus. (The rotational frequency multiples by 60 is the rotational speed per minute.) FIG. 2B is a diagram according to FIG. 2A and shows the relationship between total flutter value and rotational frequency. Data in FIG. 2A and FIG. 2B are from an experiment result, in which a disc named “AP5702 (Red)” and an optical disc apparatus with a conventional tray are used. The total flutter values listed in the third column in FIG. 2A are obtained by measuring the peak-to-peak value (Vp-p, mV) of the reflected voltage signal from the disc surface and transferring the peak-to-peak value (mV) into the total flutter value (μm); the relationship between the two values described above is that 1 mV represents 1 μm. In FIG. 2B, the x-coordinate represents the rotational frequency (Hz) of the disc that is corresponding to the data in the second column of the list in FIG. 2A; the y-coordinate represents the total flutter value (μm) that is corresponding to the data in the third column of the list in FIG. 2A.

As shown in FIG. 2B, when the rotational frequency of the disc exceeds 159.2 Hz, the disc flutter begins to increase sharply so that the track seeking executed by the OPU is going to be affected; the rotational speed which the disc begins to flutter at is called stability limit speed of the optical disc apparatus. Most optical disc apparatuses in the present market can achieve the rotational speed for 10,000 rpm; that is to say the rotational frequency exceeds 166.67 Hz. Thus, how to reduce the disc flutter when the optical disc apparatus is operating at a high speed or how to increase the stability limit speed where the disc is beginning to flutter is an urgent problem to be solved.

### SUMMARY OF THE INVENTION

The objective of the present invention is to provide an optical disc apparatus with a tray comprising at least one air-guiding opening between adjacent hooks in the front zone. The air-guiding opening releases the fluctuating airflow, thus effectively improves the disc flutter when the disc is rotating.

Another objective of the present invention is to provide an optical disc apparatus with a tray comprising an arc slot on the edge of the accommodation concave in the front zone. The arc slot releases the fluctuating airflow, thus effectively improves the disc flutter when the disc is rotating.

Another objective of the present invention is to provide an optical disc apparatus with a tray comprising a plurality of holes on the edge of the accommodation concave in the front zone. The plurality of holes release the fluctuating airflow, thus effectively improves the disc flutter when the disc is rotating.

Another objective of the present invention is to provide comprising an optical disc apparatus with a tray comprising an air-guiding opening in the front zone and inter-joined the accommodation concave. The air-guiding opening releases the fluctuating airflow, thus effectively improves the disc flutter when the disc is rotating.

Another objective of the present invention is to provide an optical disc apparatus with a tray comprising a tongue-shaped opening extending from the rear zone to the front zone. The tongue-shaped opening serves as the air-guiding opening for releasing the fluctuating airflow, thus effectively improves the disc flutter when the disc is rotating.

The advantage and spirit of the invention may be understood by the following recitations together with the appended drawings.

### BRIEF DESCRIPTION OF THE APPENDED DRAWINGS

FIG. 1 shows a tray of an optical disc apparatus according to the prior art.

FIG. 2A shows total flutter values measured from the disc under different rotational frequencies according to the prior art.

FIG. 2B is a diagram according to the data shown in FIG. 2A to show the relationship between total flutter value and rotational frequency.

FIG. 3 shows a tray used in an optical disc apparatus according to the present invention.

FIG. 4 shows another tray used in an optical disc apparatus according to the present invention.

FIG. 5 shows another tray used in an optical disc apparatus according to the present invention.

FIG. 6 shows another tray used in an optical disc apparatus according to the present invention.

FIG. 7A shows total flutter values measured from the disc under different rotational frequencies according to an embodiment of the present invention.

FIG. 7B is a diagram according to the data shown in FIG. 7A to show the relationship between total flutter value and rotational frequency.

FIG. 8A shows total flutter values measured from the disc under different rotational frequencies according to another embodiment of the present invention.

FIG. 8B is a diagram according to FIG. 8A to show the relationship between total flutter value and rotational frequency.

FIG. 9 shows the relationship between the stability limit speed of the optical disc apparatus and the area of the air-guiding hole according to the present invention.

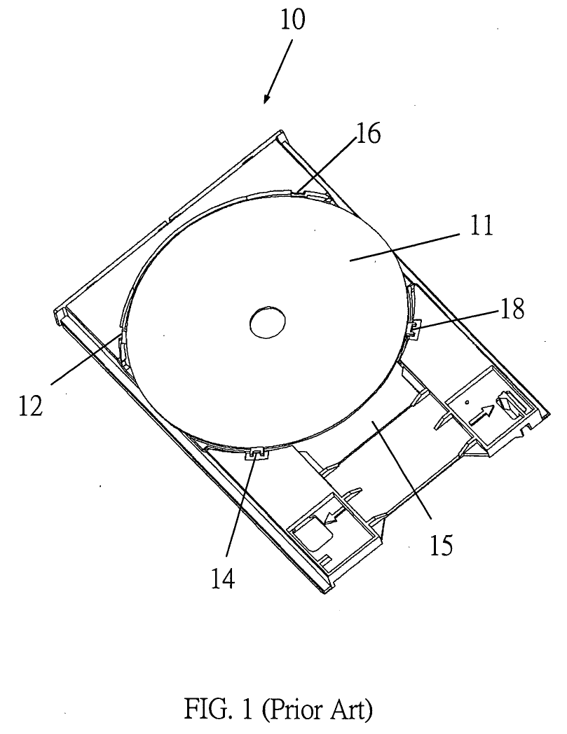

### DETAILED DESCRIPTION OF THE INVENTION

The present invention provides an optical disc apparatus comprising a housing (not shown in figures) and a tray installed in the housing for supporting a disc. The housing comprises a housing opening and the tray can be alternatively moved out and back into the housing through the housing opening. The tray comprises an accommodation concave for placing the disc. The tray also comprises a plurality of hooks disposed around the accommodation concave to prevent the disc from falling out of the accommodation concave. There is at least one air-guiding opening between the adjacent hooks in a front zone of the tray. The front zone of the tray is near the housing opening when the tray is moved back into the housing. Such configuration reduces the disc vibration when the disc is rotating.

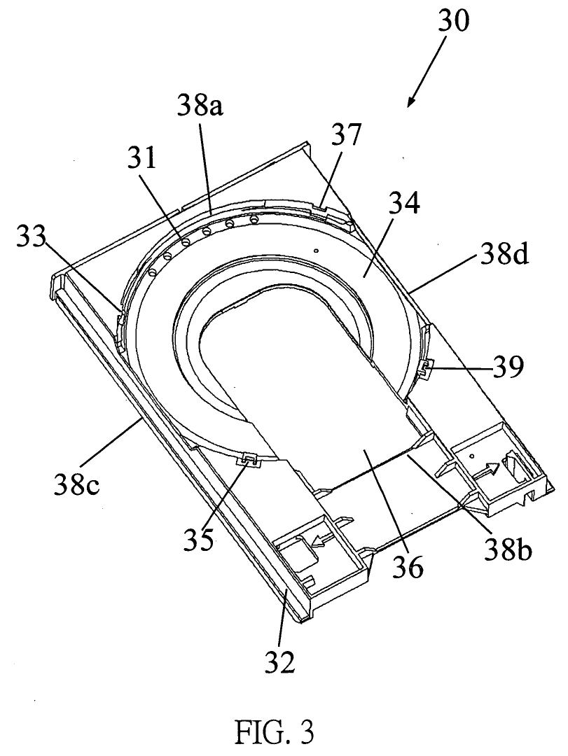

Referring to FIG. 3, it is a first embodiment that shows a tray 30 used in an optical disc apparatus according to the present invention. In the first embodiment, the tray 30 comprises a substantially rectangular plate 32 and hooks 33, 35, 37 and 39. The plate 32 comprises a front zone 38a, a rear zone 38b, two side zones 38c, 38d, and an accommodation concave 34. A tongue-shaped opening 36 extends from the rear zone 38b to the accommodation concave 34. The accommodation concave 34 of the tray 30 is for placing the disc.

As shown in FIG. 3, the hooks 33, 35, 37 and 39 are located around the accommodation concave 34, wherein the hooks 33, 35 and the hooks 37, 39 are respectively located near two side zones 38c, 38d of the plate 32 to prevent the disc from falling out of the accommodation concave 34. Furthermore, an air-guiding opening 31 is disposed between the adjacent hooks 33, 37 in the front zone 38a. In the first embodiment, the air-guiding opening 31 comprises a plurality of holes, and each diameter of the holes is approximately 3˜5 mm. When the disc is rotating, the air-guiding opening 31 guides out the fluctuating airflow generated near the hooks 33, 37 in the front zone 38a to improve disc flutter.

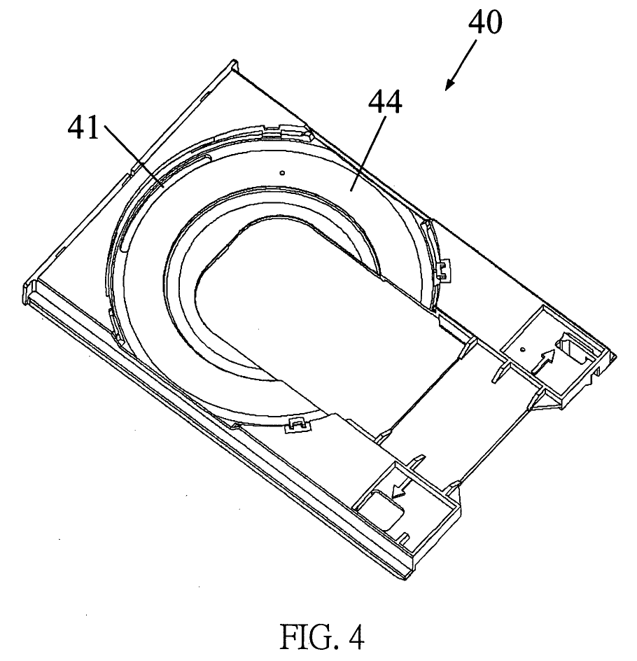

Referring to FIG. 4, it is a second embodiment that shows a tray 40 used in an optical disc apparatus according to the present invention. The second embodiment differs from the first embodiment mainly in that the air-guiding opening 41 is an arc slot disposed on the edge of the accommodation concave 44.

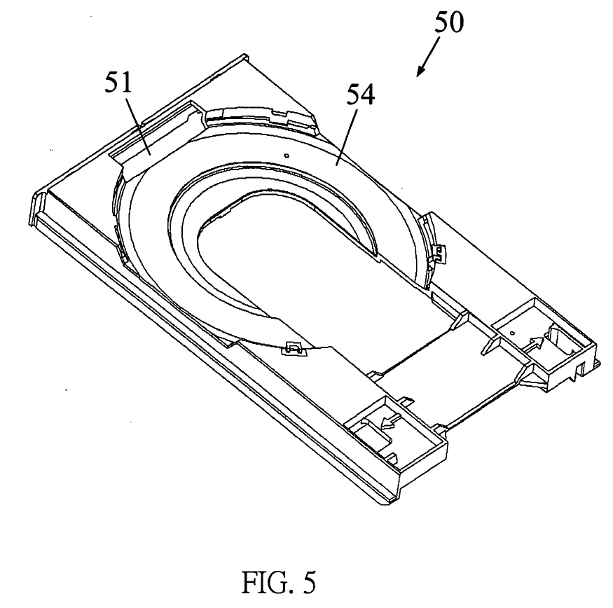

Referring to FIG. 5, it is a third embodiment that shows a tray 50 used in an optical disc apparatus according to the present invention. The third embodiment differs from above embodiments mainly in that the air-guiding opening 51 is inter-joined the accommodation concave 54.

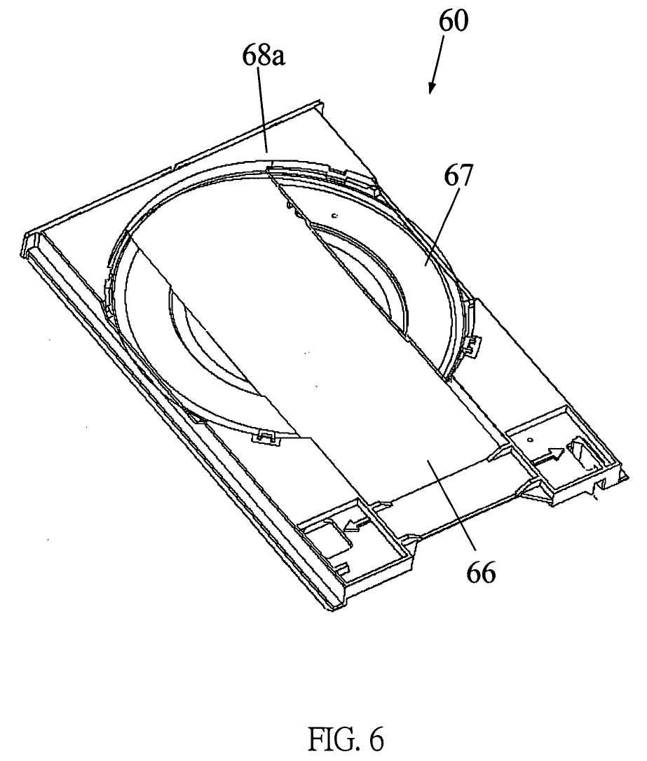

Referring to FIG. 6, it is a fourth embodiment shows a tray 60 used in an optical disc apparatus according to the present invention. The fourth embodiment differs from above embodiments mainly in that the tongue-shaped opening 66 further extends to the edge of the accommodation concave 67 in the front zone 68a to serve as the air-guiding opening.

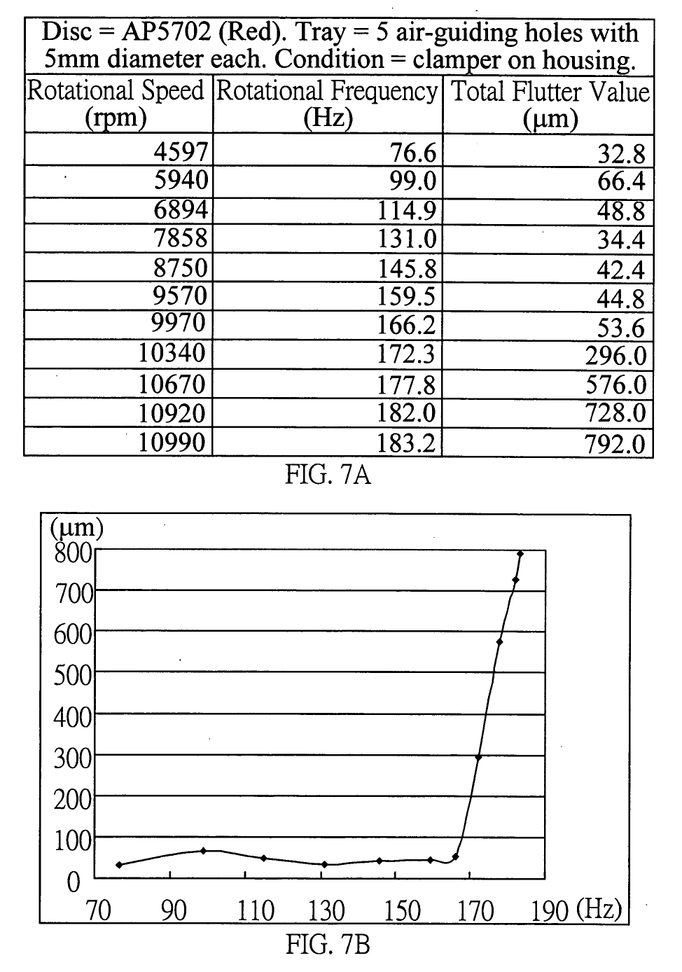

Refer to FIG. 7A and FIG. 7B. FIG. 7A shows in the optical disc apparatus with an embodiment of the present invention, total flutter values measured from the disc under different rotational frequencies. (The rotational frequency multiplies by 60 is the rotational speed per minute.) FIG. 7B is a diagram according to FIG. 7A and shows the relationship between total flutter value and rotational frequency. Data in FIG. 7A and FIG. 7B are from an experiment result, in which the same disc named “AP5702 (Red)” and the optical disc apparatus with the tray according to the present invention are used. In this embodiment, the tray comprises 5 air-guiding holes; each diameter of the air-guiding holes is 5 mm; the total area of the air-guiding holes is approximately 98 square millimeters.

The total flutter values listed in the third column in FIG. 7A are obtained by measuring the peak-to-peak value (Vp-p, mV) of the reflected voltage signal from the disc surface and transferring the peak-to-peak value (mV) into the total flutter value (μm); the relationship between the two values described above is that 1 mV represents 1 μm. In FIG. 7B, the x-coordinate represents the rotational frequency (Hz) of the disc that is referred to the data in the second column in FIG. 7A; the y-coordinate represents the total flutter value (μm) that is according to the data in the third column in FIG. 7A.

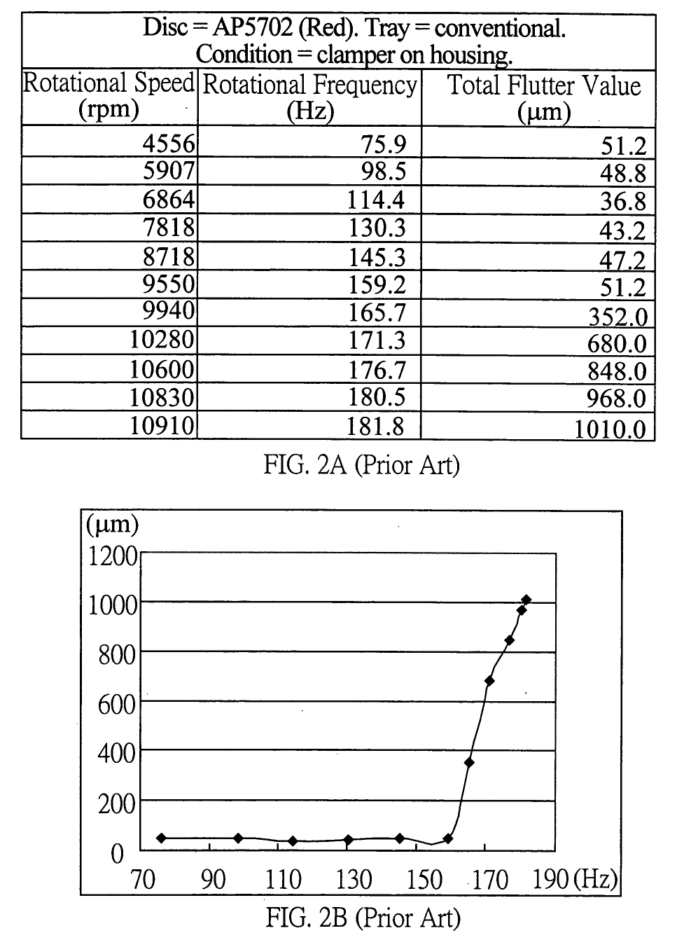

As shown in FIG. 7B, when the rotational frequency of the disc exceeds 166.2 Hz, the disc flutter begins to increase severely. In contrast to the prior-art optical disc apparatus that begins disc flutter while the rotational frequency exceeds 159.2 Hz (FIGS. 2A and 2B), it is to say that the 5 air-guiding holes of the tray indeed improve disc flutter by releasing the fluctuating airflow.

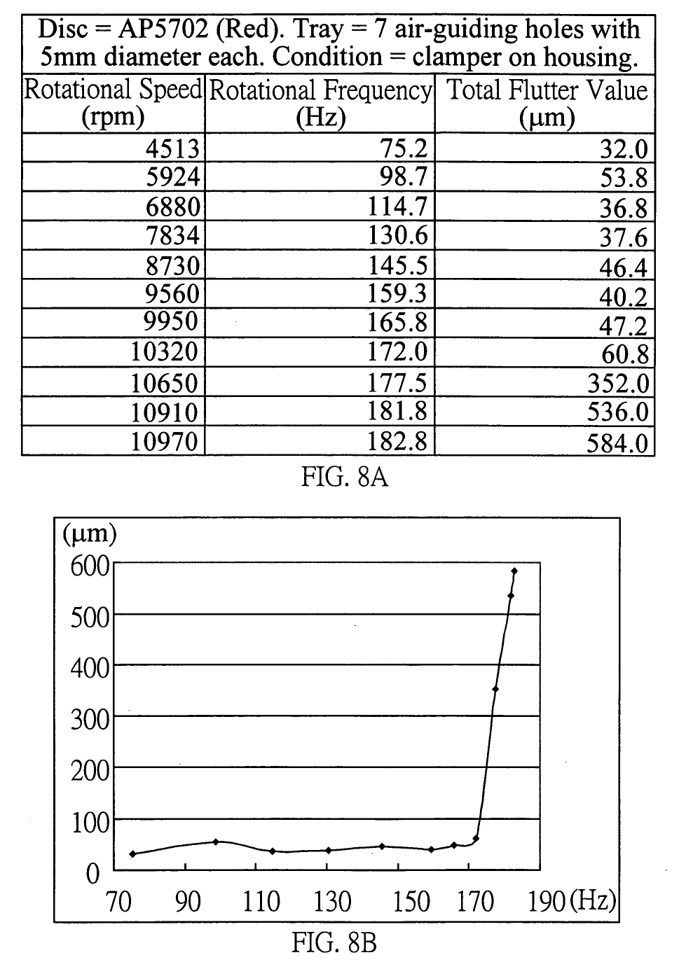

Refer to FIG. 8A and FIG. 8B. FIG. 8A shows in the optical disc apparatus with another embodiment of the present invention, total flutter values measured from the disc under different rotational frequencies. (The rotational frequency multiplies by 60 is the rotational speed per minute.) FIG. 8B is a diagram according to FIG. 8A and shows the relationship between total flutter value and rotational frequency. Data in FIG. 8A and FIG. 8B are from an experiment result, in which the same disc named “AP5702 (Red)” and the optical disc apparatus with another tray are used. In this embodiment, the tray of the optical disc apparatus comprises 7 air-guiding holes; each diameter of the air-guiding holes is 5 mm; the total area of the air-guiding holes is approximately 137 square millimeters.

The total flutter value listed in the third column in FIG. 8A are obtained by measuring the peak-to-peak value (Vp-p, mV) of the reflected voltage signal from the disc surface and transferring the peak-to-peak value (mV) into the total flutter value (μm); the relationship between the two values described above is that 1 mV represents 1 μm. In FIG. 8B, the x-coordinate represents the rotational frequency (Hz) of the disc that is referred to the data in the second column of the list in FIG. 8A; the y-coordinate represents the total flutter value (μm) that is according to the data in the third column in FIG. 8A.

As shown in FIG. 8B, when the rotational frequency of the disc exceeds 172.0 Hz, the disc flutter begins to increase severely. In contrast to the prior-art optical disc apparatus that begins disc flutter while the rotational frequency exceeds 159.2 Hz (FIGS. 2A and 2B), it is to say that the 7 air-guiding holes of the tray indeed improve disc flutter by releasing the fluctuating airflow.

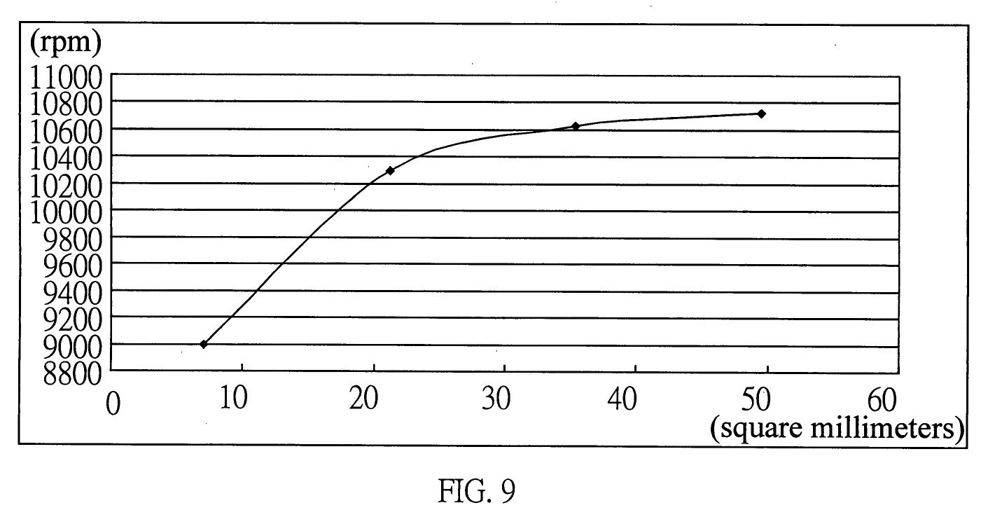

FIG. 9 shows the relationship between stability limit speed of the optical disc apparatus and total area of the air-guiding holes according to the present invention. In FIG. 9, the x-coordinate represents the total area (square millimeters) of the air-guiding holes; the y-coordinate represents the stability limit speed (rpm) of the optical disc apparatus while the disc begins to flutter. As shown in FIG. 9, the stability limit speed is increased over 10,000 rpm (166.67 Hz) when the total area of the air-guiding holes exceeds 20 square millimeters. Therefore, the optical disc apparatus can still function normally without the influence of disc flutter as operating at a high rotational speed over 10,000 rpm.

With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An optical disc apparatus comprising:
a housing; and
a tray placed in said housing for supporting a disc, said tray having:
an accommodation concave for placing said disc;
a plurality of hooks disposed around said accommodation concave to prevent said disc from falling out of said accommodation concave; and
at least one air-guiding opening disposed between said adjacent hooks in a front zone of said tray;
wherein said air-guiding opening improves the vibration of said disc when said disc is rotating.

2. The optical disc apparatus of claim 1, wherein said housing comprises an opening for said tray moving into and out from said housing, and said front zone is near said opening when said tray moves into said housing.

3. The optical disc apparatus of claim 1, wherein said air-guiding opening is an arc slot disposed on an edge of said accommodation concave.

4. The optical disc apparatus of claim 1, wherein said air-guiding opening comprises a plurality of holes disposed on an edge of said accommodation concave.

5. The optical disc apparatus of claim 4, wherein each diameter of said holes is 3˜5 millimeters (mm), and total area of all said air-guiding holes exceeds 20 square millimeters.

6. The optical disc apparatus of claim 1, wherein said air-guiding opening is in said front zone and inter-joined said accommodation concave.

7. The optical disc apparatus of claim 1, wherein said tray comprises a tongue-shaped opening extending from a rear zone of said tray to said accommodation concave.

8. The optical disc apparatus of claim 7, wherein said tongue-shaped opening further extends to an edge of said accommodation concave in said front zone for serving as said air-guiding opening.

9. The optical disc apparatus of claim 1, wherein said disc is rotated at a speed over 9600 rpm.

10. The optical disc apparatus of claim 1, wherein a fluctuating airflow is generated in the proximity of said hooks when said disc is rotating, and said air-guiding opening releases said fluctuating airflow to make said disc rotate steadily.

11. The optical disc apparatus of claim 1, wherein an area of said air-guiding opening exceeds 20 square millimeters.

12. A tray placed in a optical disc apparatus for supporting a disc, said tray comprising:
an accommodation concave for placing said disc;
a plurality of hooks disposed around said accommodation concave to prevent said disc from falling out of said accommodation concave; and
at least one air-guiding opening configured between said adjacent hooks in a front zone of said tray;
wherein said air-guiding opening configured improves vibration when said disc is rotating.

13. The tray of claim 12, wherein said optical disc apparatus comprises an opening for said tray moving into and out from said housing; and said front zone is near said opening when said tray moves into said optical disc apparatus.

14. The tray of claim 12, wherein said air-guiding opening is an arc slot disposed on an edge of said accommodation concave.

15. The tray of claim 12, wherein said air-guiding opening comprises a plurality of holes disposed on an edge of said accommodation concave.

16. The tray of claim 15, wherein each diameter of said holes is 3˜5 millimeters (mm), and total area of all said air-guiding holes exceeds 20 square millimeters.

17. The tray of claim 12, wherein said air-guiding opening is in said front zone and inter-joined said accommodation recess concave.

18. The tray of claim 12, wherein said tray comprises a tongue-shaped opening extending from a rear zone of said tray to said accommodation concave.

19. The tray of claim 18, wherein said tongue-shaped opening further extends to an edge of said accommodation concave in said front zone for serving as said air-guiding opening.

20. The tray of claim 12, wherein said disc is rotated at a speed over 9600 rpm.

21. The tray of claim 12, wherein a fluctuating airflow is generated in the proximity of said hooks when said disc is rotating, and said air-guiding opening releases said fluctuating airflow to make said disc rotate steadily.

22. The optical disc apparatus of claim 12, wherein an area of said air-guiding opening exceeds 20 square millimeters.
